(19) United States
(12) Patent Application Publication
(10) Pub. No.: US 2021/0226479 A1
(43) Pub. Date: Jul. 22, 2021

(54) WIRELESS TRANSMITTER, WIRELESS RECEIVER, AND SYSTEM

(71) Applicant: Shenzhen Depujieran Trading Co., Ltd, Shenzhen (CN)

(72) Inventor: Ranran Duan, Shenzhen (CN)

(21) Appl. No.: 17/248,121

(22) Filed: Jan. 11, 2021

(30) Foreign Application Priority Data
Jan. 16, 2020 (CN) 202010048293.6

(51) Int. Cl. H02J 50/20; H02J 50/80; H02J 50/90; H04B 1/03; H04B 1/08; H01Q 1/24

(52) U.S. Cl. CPC H02J 50/20; H02J 50/80; H01Q 1/243; H04B 1/03; H04B 1/08; H02J 50/90

(57) ABSTRACT

A wireless transmitter, a wireless receiver and a system are disclosed. The wireless transmitter includes a first upper housing; a first lower housing, wherein the first lower housing and the first upper housing are arranged opposite to each other to form a cavity; an antenna arranged on a side surface of the first upper housing; a processor circuit board arranged in the cavity, where the processor circuit board includes a UWB high-frequency transceiver module and a processor arranged on the processor circuit board.

### CROSS-REFERENCE TO RELATED APPLICATION

The present application is filed on the basis of Chinese patent application No. 202010048293.6 filed Jan. 16, 2020, and claims priority of the Chinese patent application, the entire contents of which are incorporated herein by reference.

### TECHNICAL FIELD

The present disclosure relates to an electronic product for pets, and in particular, to a wireless transmitter, a wireless receiver, and a system.

### BACKGROUND OF THE INVENTION

Currently, an electronic pet fence system is implemented by artificially setting a plane space range by using an electronic device to prevent pets from escaping and protect pets. The electronic pet fence system usually includes two parts. The first part is a device for determining the boundary. For example, a physical fence can be formed by wires (buried wires), or a virtual space barrier can be formed by radio waves. The second part is a feedback device worn by a pet. If the pet runs out of the boundary, an alarm signal can be sent by sound/spray/vibration or other modes. After a pet is trained for a certain period of time, the pet can understand where the boundary is and the penalty for exceeding the boundary, thereby reducing the probability of pet escape.

Generally, the pet's position is monitored electronically by using Global Positioning System (GPS), Received Signal Strength Indication (RSSI), magnetic field, or the like. However, the above methods have their own disadvantages. When the pet's position is monitored by using the RSSI, the positioning error is too large. When the pet's position is monitored by using the magnetic field, the boundary distance is limited, the positioning error is large, and the positioning accuracy may be easily affected by metal objects. When the pet's position is monitored by using the GPS, the positioning accuracy is poor, and the positioning may be easily affected by signals. The above electronic pet monitoring methods all have low detection accuracy.

### SUMMARY OF THE INVENTION

The present disclosure aims to resolve at least one of the technical problems in the existing technology. In view of this, the present disclosure provides a wireless transmitter, which can effectively improve positioning accuracy by providing an Ultra Wide Band (UWB) high-frequency transceiver module, so as to ensure the consistency of boundaries of an electronic fence system.

The present disclosure also provides a wireless receiver.

The present disclosure also provides a wireless electronic fence system.

According to a first aspect, an embodiment of the present disclosure provides a wireless transmitter, including a first upper housing and a first lower housing; where the first upper housing and the first lower housing are arranged opposite to each other to form a cavity; a processor circuit board is arranged in the cavity; a UWB high-frequency transceiver module and a processor are arranged in the processor circuit board; and a side surface of the first upper housing is provided with an antenna.

The wireless transmitter according to the embodiment of the present disclosure has at least the following beneficial effects: the positioning accuracy of the wireless transmitter can be effectively improved by providing the UWB high-frequency transceiver module, so as to ensure the consistency of boundaries of an electronic fence system.

In the wireless transmitter according to some embodiments of the present disclosure, an upper surface of the first upper housing is provided with a groove; and a solar charging panel is arranged in the groove.

Through the arrangement of the solar charging panel, when working outdoors, the wireless transmitter can absorb heat energy of sunlight, convert the heat energy to electric energy, and store redundant electric energy in a storage battery.

In the wireless transmitter according to some embodiments of the present disclosure, a side surface of the processor circuit board is provided with a control circuit board base; and one side of the control circuit board base away from the processor circuit board is provided with a control circuit board.

The control circuit board sends signals to the processor circuit board to enable the processor circuit board to respond.

In the wireless transmitter according to some embodiments of the present disclosure, one side of the control circuit board away from the control circuit board base is provided with several buttons and a display device; and a waterproof lining for a button is correspondingly arranged between the several buttons and the control circuit board.

The display device is provided to display the ranging distance in real time and parameters of the wireless transmitter; and the buttons are provided to adjust the parameters of the wireless transmitter. The waterproof lining for a button is provided to prevent liquid from entering the wireless transmitter through gaps between the buttons and button through-holes, and protect electronic components in the wireless transmitter from damage caused by short circuit.

In the wireless transmitter according to some embodiments of the present disclosure, a waterproof and breathable film is arranged between the first lower housing and the processor circuit board; and a peripheral edge of the waterproof and breathable film is provided with a waterproof silicone ring.

The waterproof and breathable film is provided to ensure the convection between air inside the wireless transmitter and air outside the wireless transmitter, while preventing liquid from entering the wireless transmitter, thereby avoiding the internal temperature of the wireless transmitter from being too high after a long time operation of the wireless transmitter.

According to a second aspect, an embodiment of the present disclosure provides a wireless receiver, including a ring band, a second upper housing, and a second lower housing; where the second upper housing and the second lower housing are arranged opposite to each other to form a cavity; the cavity is relatively fixed to the ring band; a processor circuit board is arranged in the cavity; and a UWB high-frequency transceiver module and a processor are arranged in the processor circuit board.

The wireless receiver according to the embodiment of the present disclosure has at least the following beneficial effects: The positioning accuracy of the wireless receiver can be effectively improved by providing the UWB high-frequency transceiver module, so as to ensure the consistency of boundaries of an electronic fence system.

The wireless receiver according to some embodiments of the present disclosure further includes a supporting seat arranged between the second lower housing and the ring band; where Flexible Printed Circuit board (FPC) antennas are arranged between the ring band and the supporting seat; and a fixing plate is arranged between the FPC antennas and the supporting seat.

The FPC antennas are arranged on both sides of the fixing plate to prevent interference of pets to signals. The FPC antennas use a high-frequency antenna (about 3.5 GHz) as a ranging antenna and a low-frequency antenna (868-915 MHz) as a communication antenna.

In the wireless receiver according to some embodiments of the present disclosure, several supporting columns are arranged on the supporting seat; and conductive silicone sleeves are arranged on the several supporting columns.

In the wireless receiver according to some embodiments of the present disclosure, a waterproof ring is arranged between the second upper housing and the second lower housing.

According to a third aspect, an embodiment of the present disclosure provides a wireless electronic fence system, including the wireless transmitter and the wireless receiver.

The wireless electronic fence system according to the embodiment of the present disclosure has at least the following beneficial effects: The positioning accuracy of the wireless receiver can be effectively improved by providing the UWB high-frequency transceiver module, so as to ensure the consistency of boundaries of an electronic fence system.

### BRIEF DESCRIPTION OF DRAWINGS

FIG. 1 is a schematic structural diagram of a wireless transmitter according to an embodiment of the present disclosure;

FIG. 2 is a schematic structural diagram of a wireless receiver according to an embodiment of the present disclosure; and

FIG. 3 is a schematic diagram of a framework of a wireless electronic fence system according to an embodiment of the present disclosure.

### DETAILED DESCRIPTION OF THE INVENTION

The concept and the technical effects of the present disclosure will be clearly and completely described below in conjunction with the embodiments to help fully understand purposes, features and effects of the present disclosure. Apparently, the described embodiments are only some embodiments of the present disclosure, and not all of the embodiments. Other embodiments obtained by a person of ordinary skill in the art based on the embodiments of the present disclosure without creative efforts shall fall within the protection scope of the present disclosure.

In the description of the present disclosure, if orientation description is involved, the orientation or position relationship indicated by, for example, “up”, “down”, “front”, “rear”, “left” and “right” is based on the orientation or position relationship shown in the drawings, and these terms are just used to facilitate description of the present disclosure and simplify the description, but not to indicate or imply that the mentioned device or elements must have a specific orientation and must be established and operated in a specific orientation, and thus, these terms cannot be understood as a limitation to the present disclosure. If a feature is called “arranged”, “fixed”, “connected” or “mounted” to another feature, it can be directly arranged, fixed or connected to another feature, or indirectly arranged, fixed, connected or mounted to another feature.

In the description of the embodiment of the present disclosure, “several” means more than one, and “a plurality of” means more than two. “greater than”, “less than”, and “exceeding” should be understood as excluding this number, and “above”, “below”, and “within” should be understood as including this number. “First” and “second” in description should be understood as distinguishing between technical features, and cannot be understood as indicating or implying relative importance or implicitly indicating the number of technical features indicated or implicitly indicating the sequence relationship of indicated technical features.

### Embodiment One

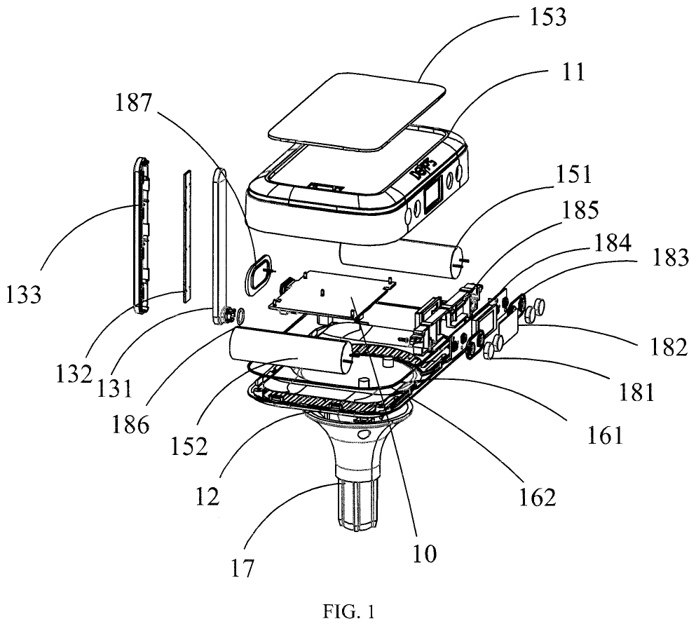

FIG. 1 is a schematic structural diagram of a wireless transmitter according to an embodiment of the present disclosure. As shown in FIG. 1, an embodiment of the present disclosure provides a wireless transmitter, including a first upper housing 11 and a first lower housing 12.

The first upper housing 11 and the first lower housing 12 are arranged opposite to each other to form a cavity; a transmitting processor circuit board 10 is arranged in the cavity; a transmitting transceiver module and a transmitting processor are arranged in the transmitting processor circuit board 10; and a side surface of the first upper housing 11 is provided with an antenna. The transmitting transceiver module is a UWB high-frequency transceiver module.

The first upper housing 11 and the first lower housing 12 can be fixed relative to each other through one or more of buckling, riveting, and screwing.

The antenna includes an antenna upper housing 131 and an antenna lower housing 133. The upper housing 131 and the antenna lower housing 133 are fixed relative to each other through buckling, screwing, and the like to form the antenna cavity. An antenna circuit board 132 is arranged in the antenna cavity, and the antenna circuit board 132 is configured to send positioning signals outward and receive external positioning feedback information.

The first upper housing 11 is provided with an antenna through-hole and a USB through-hole which are opposite to a through-hole of a display device 182. One end of the antenna is provided with an antenna junction portion. The antenna junction portion is in electrical and/or signal connection with the transmitting processor circuit board 10 inside the cavity through the antenna through-hole, so that the antenna circuit board 132 is in signal connection with the transmitting processor circuit board 10. The transmitting processor circuit board 10 generates a positioning signal, and sends the positioning signal through the antenna. In addition, positioning feedback information is transmitted back to the processor in the transmitting processor circuit board 10 through the antenna to determine position information of a pet and determine whether to generate an alarm signal according to the position information.

The USB through-hole corresponds to a USB port arranged in the transmitting processor circuit board 10, and an external USB connection port is connected to the USB port in the transmitting processor circuit board 10 through the USB through-hole to implement data transmission and charging.

In addition, the USB through-hole is also correspondingly provided with a waterproof plug 187 of a first USB charging port. When the wireless transmitter is in an uncharged state, the waterproof plug 187 of the first USB charging port corresponding to the USB through-hole prevents liquid from entering the wireless transmitter from the USB through-hole.

A waterproof antenna ring 186 is arranged on an inner side of the antenna through-hole, that is, in a gap between the antenna junction portion and the antenna through-hole, to prevent liquid from entering the wireless transmitter from the gap between them and causing short circuit of internal electronic components.

A side surface of the processor circuit board 10 is provided with a control circuit board 184 base; and one side of the control circuit board 184 base away from the transmitting processor circuit board 10 is provided with a control circuit board 184.

One side of the control circuit board 184 away from the control circuit board 184 base is provided with several buttons 181 and a display device 182; and a waterproof lining for a button is correspondingly arranged between the several buttons 181 and the control circuit board 184, where the waterproof lining may be made of soft material such as rubber. A side surface of the first upper housing 11 is provided with several button through-holes and a display device through-hole, the several button through-holes are arranged opposite to the buttons 181, and the display device 182 through-hole is arranged opposite to the display device 182.

The waterproof lining for the button is provided to prevent liquid from entering the wireless transmitter through gaps between the buttons 181 and the button through-holes.

The display device 182 displays a real-time working state and positioning feedback information in the wireless transmitter

An upper surface of the first upper housing 11 is provided with a groove; and a solar charging panel 153 is arranged in the groove of the first upper housing. Two sides of the processor circuit board are provided with several storage batteries, and the storage batteries include a first storage battery 151 and a second storage battery 152. The first storage battery 151 and the second storage battery 152 are electrically connected to the solar charging panel 153. The solar charging panel 153 is configured to convert solar energy to electric energy, and store the electric energy in the storage battery.

A waterproof and breathable film 161 is arranged between the first lower housing 12 and the processor circuit board; and a peripheral edge of the waterproof and breathable film 161 is provided with a waterproof silicone ring 162. A surface of the first lower housing 12 is provided with several heat dissipation and ventilation grooves, and the waterproof and breathable film 161 is arranged on the surface of the first lower housing 12 on the side where the processor circuit board is provided, so as to prevent liquid from entering the wireless transmitter through the heat dissipation and ventilation grooves. In addition, the waterproof and breathable film 161 is provided to ensure internal air flow in the wireless transmitter, thereby avoiding the situation that heat generated by the long-time operation of the wireless transmitter cannot be dissipated to the outside in time.

A round base 17 is arranged in a central area of the first lower housing 12, and several limiting columns are arranged on a surface of the round base 17. The processor circuit board and the first lower housing 12 are fixed relative to each other by the limiting columns. A central area of the waterproof and breathable film 161 is provided with a circular through-hole. The shape of the circular through-hole corresponds to the shape of the round base 17. The waterproof and breathable film 161 is arranged between the first lower housing 12 and the storage battery, so as to prevent the liquid outside the device from entering the device and avoid the short circuit of internal electronic components. The peripheral edge of the waterproof and breathable film 161 is provided with the waterproof silicone ring 162, so as to prevent liquid from entering the wireless transmitter from the edge of the joint between the first upper housing 11 and the first lower housing 12.

In this embodiment, the first lower housing 12 is provided with a fixing base away from the first upper housing 11, and the fixing base is configured to fix the position of the wireless transmitter.

### Embodiment Two

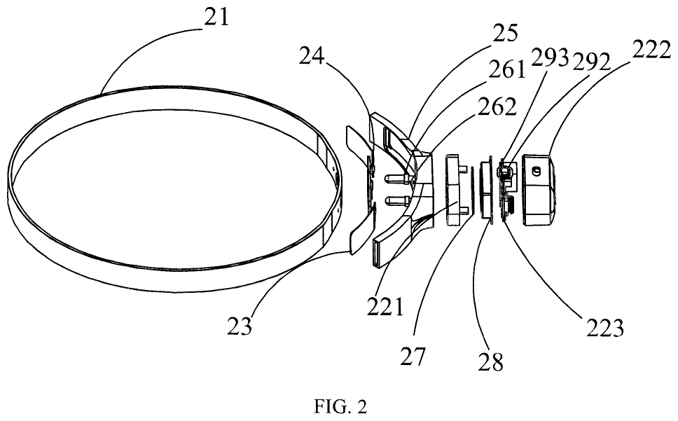

FIG. 2 is a schematic structural diagram of a wireless receiver according to an embodiment of the present disclosure. As shown in FIG. 2, the wireless receiver includes a ring band 21, a second upper housing 221, and a second lower housing 222; the second upper housing 221 and the second lower housing 222 are arranged opposite to each other to form a cavity; the cavity is relatively fixed to the ring band 21; a receiving processor circuit board 223 is arranged in the cavity; and a receiver transceiver module and a processor are arranged in the receiving processor circuit board 223. The receiver transceiver module is specifically a UWB high-frequency transceiver module.

A supporting seat 25 is arranged between the second upper housing 222 and the ring band 21; FPC antennas 23 are arranged between the ring band 21 and the supporting seat 25; and a fixing plate 24 is arranged between the FPC antennas 23 and the supporting seat 25.

Several supporting columns 261 are arranged on the supporting seat 25; and conductive silicone sleeves 262 are arranged on the several supporting columns 261. The fixing plate 24 is provided with several supporting through-holes, and the positions of the supporting through-holes in the fixing plate 24 correspond to the positions of the supporting columns 261. The supporting seat 25 can be supported and connected to the ring band 21 by the supporting columns 261.

A waterproof ring 27 is arranged between the second upper housing 221 and the second lower housing 222. The waterproof ring 27 is provided to prevent liquid from entering the wireless transmitter through the gap between the joint between the second upper housing 221 and the second lower housing 222.

A battery 28 is arranged between the second lower housing 222 and the receiving processor circuit board 223 to power the wireless receiver.

A bottom side surface of the second upper housing 221 is provided with a button 181 and a button through-hole. A waterproof soft pad for the button 181 is arranged between the button 181 and the button through-hole, to prevent liquid from entering the wireless transmitter through a gap between the button 181 and the button through-hole. The surface of one side of the second upper housing 221 away from the button through-hole is provided with a USB through-hole, and the USB through-hole is correspondingly provided with a waterproof plug 291 of a second USB charging port.

### Embodiment Three

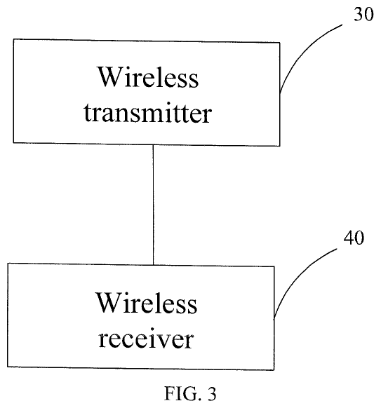

FIG. 3 is a schematic diagram of a framework of a wireless transceiving system according to an embodiment of the present disclosure. References can be made to FIG. 1.

A wireless electronic fence system includes a wireless transmitter 30 and a wireless receiver 40. The wireless transmitter 30 is internally provided with a transmitting processor circuit board 10 and a transmitting transceiver module. The wireless receiver 40 is internally provided with a receiving processor circuit board 223 and a receiving transceiver module. The transmitting transceiver module and the receiving transceiver module are UWB high-frequency transceiver modules.

The UWB high-frequency transceiver modules are controlled by the transmitting processor circuit board 10 and the receiving processor circuit board 223 respectively to accurately obtain positioning feedback information and receiving time stamps, and the positioning feedback information and the receiving time stamps are transmitted to the processor of the wireless transmitter. The processor performs ranging calculation processing on the positioning feedback information and the receiving time stamps to obtain distance information.

The above ranging calculation processing is to calculate and obtain distance information by using a time-of-flight ranging method, that is, to determine the distance between the wireless transmitter and the wireless receiver based on the time-of-flight of the radio.

Specifically, the transmitting transceiver module in the transmitting processor circuit board 10 serves as an initiator to start measurement, and the receiving transceiver module in the receiving processor circuit board 223 serves as a response initiator and a response monitor to calculate measurement data.

In a complete ranging process, the transmitting transceiver module and the receiving transceiver module transmit positioning signals and positioning feedback information for three times.

In each signal transmission process, the wireless receiver and the wireless transmitter accurately add time stamps to sending and receiving time of positioning signals and positioning feedback information, that is, the three signal transmissions include six time stamps in total.

The working principle of the wireless transceiving system according to the embodiments of the present disclosure will be further described below.

In a preset ranging stage, the transmitting transceiver module enters a positioning signal sending stage, and the receiving transceiver module enters a positioning feedback information sending stage.

At time Tₐ₁, the transmitting transceiver module sends a positioning signal, records the time Tₐ₁ when the transmission starts, and switches to a receiving state after a preset time period.

At time T_{b1}, the receiving transceiver module receives the positioning signal, and records the receiving time T_{b1}.

At time T_{b2} (T_{b2}=T_{b1}+T_{reply1}), the receiving transceiver module sends positioning feedback information, records the transmission time T_{b2}, and switches to the receiving state after the transmission is completed.

At time Tₐ₂, the transmitting transceiver module receives the positioning feedback information, and records the receiving time Tₐ₂.

At time Tₐ₃ (Tₐ₃=Tₐ₂+T_{reply2}), the transmitting transceiver module sends a final data packet, and records the sending time Tₐ₃. In addition, the transmitting transceiver module compresses the recorded time Tₐ₁, Tₐ₂, and Tₐ₃ into a final data packet, and sends the final data packet to the receiving transceiver module.

At time T_{b4}, the receiving transceiver module receives the final data packet, records the receiving the time T_{b4}, and extracts, from the final data packet, the time Tₐ₁, Tₐ₂, and Tₐ₃ recorded by the transmitting transceiver module.

The receiving transceiver module calculates the time based on information of six time points Tₐ₁, Tₐ₂, Tₐ₃, T_{b1}, T_{b2}, and T_{b3}, so as to obtain T_{round} (time difference from sending to receiving of a single device) and T_{reply} (time difference from receiving to sending of a single device). The equations are as follows:

T_{round1}=Tₐ₂−Tₐ₁

T_{round2}=T_{b3}−T_{b2}

T_{reply1}=T_{b2}−T_{b1}

T_{reply2}=Tₐ₃−Tₐ₂

The time-of-flight Tₚᵣₒₚ of electromagnetic wave is calculated by using the following equations based on T_{round} and T_{reply} calculated above:

$${\hat{T}}_{prop} = \frac{( {T}_{round 1} \times {T}_{r o u n d 2} - {T}_{reply 1} \times {T}_{reply 2} )}{( {T}_{round 1} + {T}_{r o u n d 2} + {T}_{reply 1} + {T}_{reply 2} )}$$

At this time, the measurement distance can be obtained by multiplying a receiving time difference by the speed of light based on a time-of-flight ranging method.

Because T_{round} and T_{reply} are independently measured by the wireless transmitter and the wireless receiver using their own local clocks, and their respective clocks have clock offset errors of nominal frequency, the obtained time-of-flight has certain errors. The error can be calculated using the following equation:

error=\hat{T}ₚᵣₒₚ*k

where k is the parts per million (PPM) error between the clocks of the wireless transmitter 30 and the wireless receiver 40. In this embodiment, the wireless transmitter and the wireless receiver both use crystal oscillators with an accuracy of 10 ppm and a frequency of 38.4 MHz, so the combination error is 20 ppm, that is, k is 2×10⁻⁶.

When the measurement distance is 100 m, the time-of-flight is 333 ns, and thus the error is 20×10⁻⁶×333×10⁻⁹ seconds, that is, 6.7×10⁻¹² seconds, which can be translated into a distance of about 2 mm.

In the long-distance measurement, the diffraction performance of radio can be improved by using lower frequency, and the effective measurement range can also be increased by reducing the code rate. In this embodiment, a center frequency of 3494.4 MHz, a bandwidth of 499.2 MHz and a code rate of 110 kbps are used, and the measured positioning distance can exceed 150 m.

The embodiments of the present disclosure are described in detail above with reference to the accompanying drawings, but the present disclosure is not limited to the above embodiments; and within the scope of knowledge possessed by a person of ordinary skill in the art, various changes can also be made without departing from the purpose of the present disclosure. In addition, the embodiments of the present disclosure and features in the embodiments can be combined with each other provided that no conflict occurs.

### REFERENCE NUMERALS

10, Transmitting processor circuit board
11, First upper housing
12, First lower housing
17, Round base
21, Ring band
23, FPC antenna
24, Fixing plate
25, Supporting seat
27, Waterproof ring
28, Battery
131, Antenna upper housing
132, Antenna circuit board
133, Antenna lower housing
151, First storage battery
152, Second storage battery
153, Solar charging panel
161, Waterproof and breathable film
162, Waterproof silicone ring
181, Button
182, Display device
183, Waterproof lining for a button
184, Control circuit board
185, Control circuit board base
186, Waterproof antenna ring
187, Waterproof plug of a first USB charging port
221, Second upper housing
222, Second lower housing
223, Receiving processor circuit board
261, Supporting column
262, Conductive silicone sleeve
291, Waterproof plug of a second USB charging port
292, Receiver button
293, Lining for receiver buttons

What is claimed is:

1. A wireless transmitter, comprising:
a first upper housing;
a first lower housing, wherein the first lower housing and the first upper housing are arranged opposite to each other to form a cavity;
an antenna arranged on a side surface of the first upper housing;
a processor circuit board arranged in the cavity, wherein the processor circuit board comprises:
a UWB high-frequency transceiver module arranged on the processor circuit board; and
a processor arranged on the processor circuit board.

2. The wireless transmitter of claim 1, wherein,
the first upper housing is provided with a groove arranged on an upper surface of the first upper housing; and
the groove of the first upper housing is provided with a solar charging panel arranged in the groove.

3. The wireless transmitter of claim 1, wherein,
a side surface of the processor circuit board is provided with a control circuit board base arranged on a side surface of the processor circuit board; and
the control circuit board is provided with a control circuit board arranged on one side of the control circuit board base away from the processor circuit board.

4. The wireless transmitter of claim 3, wherein,
the control circuit board is provided with a plurality of buttons and a display device arranged on one side of the control circuit board away from the control circuit board base; and
a waterproof lining for a button is correspondingly arranged between the several buttons and the control circuit board.

5. The wireless transmitter of claim 1, wherein,
a waterproof and breathable film is arranged between the first lower housing and the processor circuit board; and
the waterproof and breathable film is provided with a waterproof silicone ring arranged at a peripheral edge of the waterproof and breathable film.

6. A wireless receiver, comprising:
a second upper housing, and
a second lower housing, wherein the second lower housing and the second upper housing are arranged opposite to each other to form a cavity;
a ring band, wherein the cavity is fixed to the ring band;
a processor circuit board arranged in the cavity, wherein the processor circuit board comprises:
a UWB high-frequency transceiver module arranged on the processor circuit board; and
a processor arranged on the processor circuit board.

7. The wireless receiver of claim 6, further comprising:
a supporting seat arranged between the second lower housing and the ring band;
a plurality of FPC antennas arranged between the ring band and the supporting seat; and
a fixing plate arranged between the FPC antennas and the supporting seat.

8. The wireless receiver of claim 7, wherein
the supporting seat is provided with a plurality of supporting columns arranged on the supporting seat; and
each of the supporting columns is provided with a conductive silicone sleeve arranged on the each of the supporting columns.

9. The wireless receiver of claim 6, wherein,
a waterproof ring is arranged between the second upper housing and the second lower housing.

10. A system, comprising the wireless transmitter of claim 1.

11. A system, comprising the wireless receiver of claim 6.
